(19) United States
(12) Patent Application Publication
(10) Pub. No.: US 2015/0345409 A1
(43) Pub. Date: Dec. 3, 2015

(54) METHOD FOR ASCERTAINING THE FUEL QUALITY IN AN INTERNAL COMBUSTION ENGINE, IN PARTICULAR OF A MOTOR VEHICLE

(71) Applicant: ROBERT BOSCH GMBH, Stuttgart (DE)

(72) Inventors: Stefan BOLLINGER, Marbach Am Neckar (DE); Joachim PALMER, Korntal-Muenchingen (DE); Michael WALTER, Kornwestheim (DE)

(21) Appl. No.: 14/651,659

(22) PCT Filed: Nov. 22, 2013
(86) PCT No.: PCT/EP2013/074442

§ 371 Date: Aug. 12, 2015

(30) Foreign Application Priority Data
Dec. 12, 2012 (DE) 102012222899.3

(51) Int. Cl. F02D 19/06; F02D 41/24

(52) U.S. Cl. CPC F02D 19/0636; F02D 41/2438

(57) ABSTRACT

A method is provided for ascertaining the fuel quality in an internal combustion engine, in particular of a motor vehicle, in which it is provided, in particular, that a two-stage zero quantity calibration is carried out, in which, in the first stage, a test injection is carried out with a control duration and a first quantity correction is generated, and, in the second stage, two test injections are carried out with the mentioned control duration, whose time interval is selected in such a way that the influence of a pressure wave which is generated by the first test injection on the second test injection is preferably low, and a second quantity correction is generated on the basis of the two test injections, and the first quantity correction and the second quantity correction are compared with one another and the fuel quality is inferred from the result of the comparison.

### FIELD OF THE INVENTION

The present invention relates to a method for ascertaining the fuel quality in an internal combustion engine, in particular of a motor vehicle.

### BACKGROUND INFORMATION

In modern internal combustion engines of motor vehicles, such as, for example, self-igniting diesel engines having a common rail injection system, it is known that the total injection quantity calculated on the basis of the respective torque request by the vehicle driver is split into multiple partial injections. For example, the total injection quantity of an injector is split into one or multiple pilot injections and one main injection.

In order to minimize emission disadvantages, the injection quantities of the pilot injections must be preferably small, but on the other hand also large enough to always discharge the minimum quantity of fuel required by the engine, taking into account sources of tolerance.

Two important sources of tolerance for the quantity precision of the pilot injections are the drift of an injector over the operating time, due to the technical design, and the fuel pressure wave caused by the opening and closing of an injector.

According to German Published Patent Application No. 199 45 618 A1, the drift of an injector is adapted or compensated for with the aid of the method of zero quantity calibration or zero quantity correction. In this method, the control duration of an injector valve is varied until a change occurs in an operating parameter characterizing the rotational uniformity of the internal combustion engine. The control duration obtained during this micro quantity or zero quantity calibration operation (known as ZFC=Zero Fuel (Quantity) Calibration) is stored as the minimum control duration. This stored value is subsequently used to correct the fuel metering during the injection.

It is also known to take into account the quantity inaccuracies already when manufacturing the injectors, namely based on a so-called injector quantity adjustment (IQA). A method and a device for carrying out the IQA are described, for example, in the previously published German Published Patent Application No. 102 15 610 A1. Therein it is provided to detect the individual injection quantities of an injector at multiple test points, namely after manufacture of the injectors. The deviations of the respective injection quantities from a setpoint value ascertained empirically beforehand are detected in this case. This information is imparted to the injector with the aid of a suitable data carrier, so that this information is also available during operation.

German Published Patent Application No. 10 2004 053 418 A1 describes a method and a device for controlling chronologically successive injections in an injection system of an internal combustion engine, taking into account the mentioned fuel pressure waves. The injection quantity error triggered by the pressure wave is compensated for via a controlled pressure wave or quantity wave compensation.

Furthermore, European Published Patent Application No. 2 297 444 A1 describes a method and a device for controlling an injection system of an internal combustion engine, in which at least two chronologically successive partial injections are compensated for with the aid of pressure wave compensation. In a cylinder of the internal combustion engine, two test injections are applied at a predefined time interval from one another, and the total injection quantity of the at least two test injections is ascertained. A resulting deviation between the total injection quantity thus ascertained and a total injection quantity to be expected is assumed as an error of the pressure wave compensation, and a correction value for the pressure wave compensation is determined therefrom.

It is known that the quality of fuel is very different in different countries or regions. In Europe, for example, fuel is standardized as EN590 within relatively tight limits and is available as such on the market. In the U.S., however, a wide range of fuel qualities may be found. A lower-quality fuel having, for example, too low a cetane number may result in a longer ignition delay and thus to an undesired shift of the combustion point toward “retard.”

To parameterize the injection parameters, therefore, it is necessary to use a compromise data set which is suitable for mid-grade fuels and which, in the case of good or poor fuel grades, results in an abnormality during the combustion which is still acceptable.

### SUMMARY

One object of the present invention was therefore to improve the aforementioned disadvantages of known internal combustion engines or of the injection systems used therein, in such a way that the fuel quality may be ascertained with preferably little technical effort and low additional costs, whereby in particular it may be determined whether a fuel having a relatively low cetane number has been filled into the tank.

Since a cetane number which is too low also increases the ignition delay, this results in incomplete combustion, in particular during the ZFC calibration operation mentioned at the outset, and thus to a considerable falsification of the calibration result. Incomplete combustion occurs, for example, in self-igniting internal combustion engines, in particular at high rail pressures.

According to the concept of the present invention, lower-quality fuel is detected with the aid of a two-stage zero quantity calibration, in which, in the first stage, a micro quantity or zero quantity calibration according to the related art is carried out, and, in the second stage, two test injections are applied, in which the time interval is selected in such a way that the aforementioned pressure wave influence is preferably low. This procedure takes place preferably in the coasting mode of the internal combustion engine.

According to the present invention, the fuel quality may also be ascertained with the aid of a two-stage learning process, in which, in a first learning phase, a zero quantity calibration according to the related art is taught and a quantity correction is ascertained. In a second learning phase, taking into account the quantity correction ascertained in the first learning phase, the two test injections are applied. The quantity corrections ascertained in the first and second learning phases are related to one another or compared with one another and the fuel quality is inferred from the result of this comparison.

The present invention makes it possible to detect fuels of inferior quality, in particular in self-igniting internal combustion engines (for example common rail diesel engines), but may in principle also be applied to externally ignited internal combustion engines (i.e., gasoline engines) with the advantages described herein.

In a control unit of the internal combustion engine, according to the present invention a check may be carried out as to whether an inferior fuel having a low cetane number has been filled into the tank. If it is detected that an inferior fuel has been filled into the tank, control parameters of the internal combustion engine, namely preferably control parameters of the injection system, may be changed in such a way that the best possible combustion and the best possible engine performance may be achieved despite the inferior or lower-quality fuel.

Further advantages and embodiments of the present invention result from the description and the appended drawings.

It is understood that the features mentioned at the outset and those yet to be explained below may be used not only in the combination specified in each case but also in other combinations or alone, without departing from the scope of the present invention.

### BRIEF DESCRIPTION OF THE DRAWINGS

FIG. 1 shows exemplary embodiments of the method according to the present invention.

FIG. 2a shows the curve over time of the electrical control, known per se, for learning within the context of a ZFC calibration.

FIG. 2b shows, corresponding to FIG. 2a, the curve over time for the actual operation including the use of the ZFC according to the related art, namely for an injection pattern involving one pilot injection VE and one main injection HE.

FIG. 3 shows a signal sequence during injector activation obtained according to the present invention.

### DETAILED DESCRIPTION

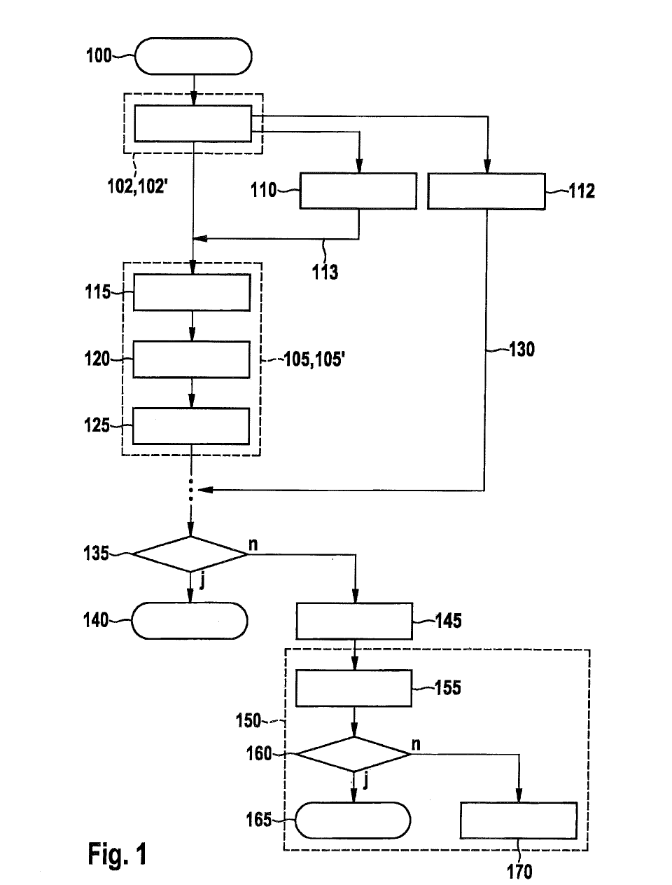

FIG. 1 shows a flow chart based on which exemplary embodiments of the method according to the present invention for ascertaining the fuel quality, in the present case in a diesel engine of a motor vehicle, are described. However, it should be noted that the method may be used not only in the case of self-igniting internal combustion engines but also in the case of externally ignited internal combustion engines (for example gasoline engines) with the advantages described herein.

The provided method is based on an aforementioned ZFC calibration according to the related art, but the calibration according to the present invention takes place in two chronologically successive calibration phases or steps 102, 105 and 102′, 105′.

After start 100 of the routine, according to a first exemplary embodiment, individual test injections (not shown here in detail) take place in first calibration step 102, as known per se during the ZFC calibration, each with a fixed control duration of an injector valve, the control duration being varied from test injection to test injection until a change occurs in an operating parameter characterizing the rotational uniformity of the internal combustion engine. Control duration AD_ZFC obtained during the ZFC calibration is assumed to be the minimum control duration and may be converted, as likewise known per se, into a first quantity replacement signal ME1. As known from the related art described at the outset, this conversion may take place on the basis of the rotational speed of the internal combustion engine or an oxygen or ion current signal of a lambda sensor which is optionally provided in the internal combustion engine. The first quantity replacement signal ME1 may optionally be averaged over multiple measuring cycles. The resulting minimum control duration AD_ZFC and the first quantity replacement signal ME1 are buffered 110, 112 and, as described below, put to further use.

In the second calibration step 105, two test injections are carried out 115, 120 on the same injector and the same cylinder of the internal combustion engine in chronological succession with in each case the control duration AD_ZFC stored in first step 102 and called up from or supplied by buffer memory 110 in step 113. The time interval between the two mentioned test injections is selected in such a way that the above-described influence of the first injection on the second injection due to the fuel pressure wave formed during the first injection is preferably low or is negligible.

Here, use is made in particular of the fact that lower-quality fuel is noticeable in particular in individual injections since, when an injection pattern involving multiple partial injections is used, the cetane number is of little relevance. The cause of this technical effect lies in the fact that the fuel is already partially “pre-cracked” during the first test injection, but is not fully combusted (for example due to incomplete oxidation to CO instead of to CO₂). When a further injection takes place thereafter, the combustion chamber is already pre-conditioned by the uncombusted portions, so that the second test injection combusts well together with the incomplete residues of the first test injection. If no second injection takes place, the incomplete combustion products are merely conveyed into the exhaust gas of the internal combustion engine and therefore make no contribution to torque (i.e., the ZFC signal is accordingly lower). In the case of a double injection, however, the entire fuel quantity forms torque. In a fuel of sufficient quality, both individual test injections and also double injections combust fully. The expected value for the quantity ratio in this case is therefore approximately or almost 2:1.

If quantity replacement signal ME2 ascertained 125 in second calibration step 105 turns out in test step 135 to be twice as great as quantity replacement signal ME1 ascertained in first step 102 and called up from or supplied by buffer memory 112 in step 130, within an empirically predefinable deviation or threshold ΔM_thres, then according to the provided method it is inferred therefrom that the cetane number lies within the permissible range, and the routine ends with step 140.

It should be noted that the described relationship between the two quantity replacement signals ME1 and ME2 may be satisfied only when a combustion to the greatest possible extent has taken place during the test injections.

However, if quantity replacement signal ME2 ascertained in the second step is considerably more than twice as great as quantity replacement signal ME1 ascertained in the first step, according to the equation

ME2≧2*ME1+ΔM_thres

or considerably less than twice as great as quantity replacement signal ME1 ascertained in the first step, according to the equation

ME2≦2*ME1+ΔM_thres

then the fuel is assumed to have a relatively low cetane number. In this case, an error signal such as, for example, “Cetane number too low” is output 145 to the control unit, so that the latter if necessary changes the ignition points of the partial injections (i.e., of the pilot injections and/or of the main injections) in such a way that the excessively low cetane number is compensated for.

In the method shown in FIG. 1, according to a second exemplary embodiment, a two-stage learning process may be provided, with the aid of which the fuel quality (for example the cetane number) may be ascertained even more reliably. The two learning phases or learning stages are delimited from one another by the dashed lines 102′, 105′ shown in FIG. 1.

In first learning phase 102′, once again a ZFC calibration according to the related art is carried out, in which individual test injections are likewise carried out. The ZFC is fully taught, as known per se, and control duration AD_learned ascertained in the taught state for a respective injector is stored. As described at the outset, a corresponding first quantity replacement signal ME1_learned is once again calculated from the stored value of control duration AD_learned, and is likewise buffered.

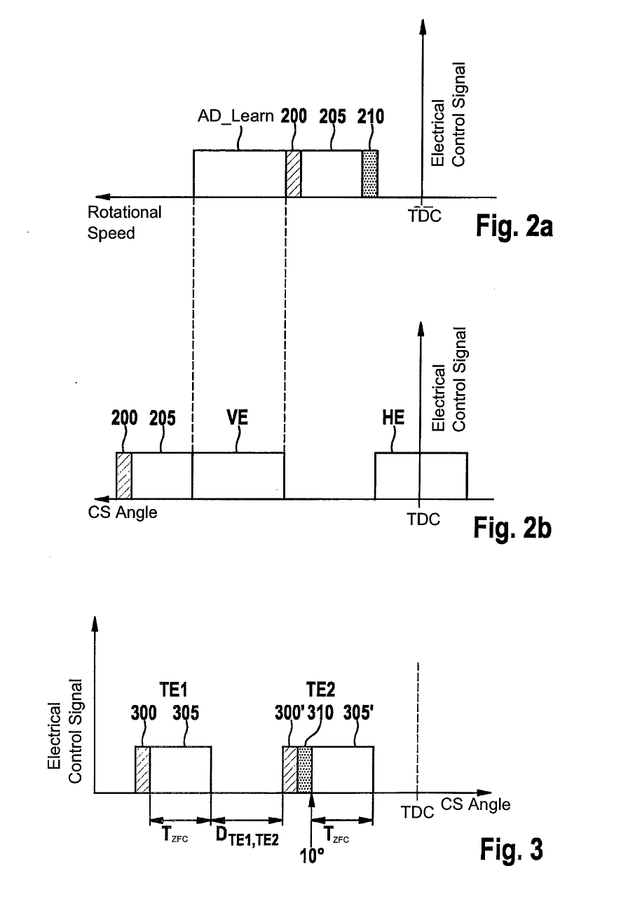

The calibration steps carried out in second learning phase 105′ will be described with reference to FIGS. 2 and 3 and are derived from the related art (in particular FIG. 6 of European Patent No. 2 297 444 B1). As shown in FIG. 2, the corrections of an injector quantity adjustment (IQA) 200 described at the outset and known per se, of learned value 205 and of a cylinder counterpressure compensation 210 known per se in the related art are taken into account.

FIG. 2a shows the curve over time of the electrical control, known per se, for learning within the context of a ZFC calibration. The control is placed at a predefinable crankshaft angle (CS-angle) or at a corresponding point in time before the top dead center (TDC). The dead centers are the positions of the crankshaft of an internal combustion engine in which the piston does not carry out any further movement in the axial direction. The position of the dead centers is clearly defined by the geometry of the crankshaft, connecting rod and piston. A distinction is made between top dead center (TDC) (the upper side of the piston is located close to the cylinder head) and the bottom dead center (BDC), i.e., the upper side of the piston is remote from the cylinder head.

The total control duration is composed of a basic portion from the control duration characteristic map, a portion from the IQA (likewise according to the related art described at the outset), a portion from the ZFC based on the already-learned value from the EEPROM, and a portion from cylinder counterpressure compensation 210. Cylinder counterpressure compensation 210 compensates for the effect that the injection quantity depends not only on the control duration and, in the case of an assumed common rail injection system, the respective rail pressure, but also on the cylinder counterpressure.

FIG. 2b shows, corresponding to FIG. 2a, the curve over time for the actual operation including the use of the ZFC according to the related art, namely for an injection pattern involving one pilot injection VE and one main injection HE.

As is apparent from FIG. 3, two test injections TE1, TE2 are activated on an individual cylinder in learning phase 2 in the coasting mode of the internal combustion engine, namely using the drift correction ascertained in learning phase 1. During these test injections TE1, TE2, a counterpressure compensation is additionally carried out in each case. In the diagram shown, once again the electric control signal of an injection system (not shown) is plotted as a function of the crankshaft angle (CS angle), the top dead center (TDC) also being indicated.

The coasting mode denotes a driving state of the motor vehicle in which, with the traction not disconnected, for example with the clutch pedal not pressed, the internal combustion engine is dragged by the motor vehicle and thus kept in rotary motion.

Test injection TE1 is in the present case composed of two control signal components 300, 305. Component 300 is a correction term based on the counterpressure compensation, whereas the second component 305 is a term resulting from the ZFC, namely with a chronological length T_{ZFC}. According to the related art, the parameter T_{ZFC} already includes the IQA and an above-described control duration characteristic map.

In the present case, the second partial injection TE2 takes place after a time delay D_{TE1,TE2}. The control signal is once again composed of a first correction term 300′, resulting from the counterpressure compensation, and a second term 305′, resulting from the ZFC. The hatching is intended to indicate that terms 300 and 300′ and respectively 305 and 305′ are not necessarily identical.

In contrast to first test injection TE1, the control signal contains a further correction term 310 which results from the pressure wave compensation (PWC) and which also encompasses the above-described iteration with the aid of feedback. In the present exemplary embodiment, control component 310 ends at a CS angle of 10 degrees. As in learning phase 1, the corrections of the IQA (see FIG. 2, reference numeral 200) and of the cylinder counterpressure compensation (see FIG. 2, reference numeral 210) are also taken into account here.

The time interval between the mentioned two test injections TE1 and TE2 is selected to be so great that the above-described fuel pressure wave may already be regarded as decayed and may therefore be neglected. As a result, the pressure wave compensation is dispensed with (see FIG. 3, reference numeral 220). Alternatively, the interval may be selected in such a way that, although there is still a residual influence of the pressure wave, this may still be sufficiently compensated for via the pressure wave compensation.

At the end of the two-stage learning phase, the total injection quantity of the two test injections is once again ascertained according to the ZFC principle, namely based on the rotational speed of the internal combustion engine or an oxygen or ion current signal of a lambda sensor which is optionally provided in the internal combustion engine. The quantity replacement signal may once again be averaged over multiple measuring cycles.

In this exemplary embodiment, the two learning phases 102′, 105′ are followed, instead of steps 135-145, by an evaluation phase 150 in which quotient ME2_learned/ME1_learned is formed 155 from the values of quantity replacement signals ME2_learned and ME1_learned ascertained (i.e., averaged as described at the outset) from second learning phase 105′ and first learning phase 102′, the quotient then being compared 160 with an empirically predefined value. In the present exemplary embodiment, the quotient is compared with the ratio 2 to be expected in the case of fuel of average quality. If the quotient corresponds to value 2, then it is thus assumed that the fuel newly filled into or located in the fuel tank is of sufficient quality, i.e., in the present exemplary embodiment has a sufficiently high cetane number, and the routine thus ends 165.

If the ascertained quotient is considerably greater than the ratio of 2 which is to be expected, then it is assumed that fuel of inferior quality has been filled into the tank. In this case, one or multiple of the following measures may be taken 170 by the injection system:
a) adapting injection parameters, carried out in the actual operation of the internal combustion engine, in order to shift the ignition point toward “advance to compensate” for the increased ignition delay due to the lower-quality fuel.
b) carrying out the ZFC on the basis of a described double injection, in which the injector drift is ascertained from the double injection pattern. It may be assumed here that the residual error due to the fuel pressure wave which has not yet fully decayed is considerably smaller than the error occurring with a low fuel quality during the ZFC standard operation involving just one test injection. Under this assumption, an injection pattern involving the described double injection may be used to learn the drift compensation in a very good approximation, and the resulting quantity signal may be converted by halving into a quantity signal which is to be expected in the case of a single injection. The quantity signal thus ascertained may then be supplied to the ZFC evaluation algorithm which is customary in the related art.
c) carrying out a (possibly controlled) compensation of the quantity replacement signal values ascertained in learning phase 1, depending on the ascertained quotient. One possible approach is based on the fact that, if the fuel quality is sufficient, factor 2 results when ME1 combusts optimally. It is assumed here in particular that the conversion factor is equal to value 1 and the following equation applies:

ME2/Fac_{conversion}*ME1ₒₚₜᵢₘₐₗ=2

If the conversion during the standard ZFC operation is, for example, only 80%, then a quotient of 2.5 results instead of a quotient of 2. In other words, a conversion factor may be determined from an ascertained quotient of 2.5.

The reciprocal value of the ascertained conversion factor may then be used as compensation factor during the standard operation on the ascertained quantity signal, namely according to the relationship:

Signal measured=Fac_{conversion}*Signalₒₚₜᵢₘₐₗ→Signalₒₚₜᵢₘₐₗ=Signal measured/Fac_{conversion}
d) changing the diagnosis limits for monitoring the zero quantity calibration. The diagnosis of the zero quantity calibration takes place in this case on the basis of the control duration. Here, the sum of the control durations is calculated from the control duration characteristic map, the IQA and the ZFC learning value and is monitored for a min/max value. If a low-quality fuel is detected, it may be assumed that the learning values of the ZFC accordingly increase and thus a higher max value may be permitted.

The calibration sequence described at the outset is implementable in a control unit code of an internal combustion engine of a motor vehicle, for example in the form of an EEPROM or as a control program. The calibration sequence has an influence on the energization profiles on individual injectors in the coasting mode of a fuel injection system involved here, and may be used on both magnetic valve systems and piezoelectric systems. In particular, it may be used in countries or regions in which inferior or lower-quality fuels are sold, for example in the U.S.

1.-10. (canceled)

11. A method for ascertaining a fuel quality in an internal combustion engine, comprising:
carrying out a two-stage zero quantity calibration, wherein:
in a first stage of the calibration, at least one test injection is carried out with a control duration and a first quantity correction is generated,
in a second stage of the calibration, at least two test injections are carried out with the control duration,
a time interval of the control duration is selected in such a way that an influence of a pressure wave that is generated by a first test injection on at least a second test injection is low, and
a second quantity correction is generated on the basis of the at least two test injections;
comparing the first quantity correction and the second quantity correction with one another; and
inferring the fuel quality from a result of the comparing.

12. The method as recited in claim 1, wherein the method is carried out in a coasting mode of the internal combustion engine.

13. The method as recited in claim 1, wherein at least one of the control duration, the first quantity correction, and the second quantity correction is ascertained based on a two-stage learning process, in which, in a first learning phase, a zero quantity calibration is taught with the aid of a test injection and a first learned quantity correction is ascertained, and, in a second learning phase, taking into account the first quantity correction ascertained in the first learning phase, the two test injections are carried out, and the first quantity correction and the second quantity correction are compared with one another and the fuel quality is inferred from the result of the comparison.

14. The method as recited in claim 11, further comprising averaging at least one of the first quantity correction and the second quantity correction over multiple measuring cycles.

15. The method as recited in claim 11, further comprising carrying out a check as to whether the second quantity correction, within a predefinable deviation, is more or less than twice as great as the first quantity correction, wherein the fuel quality is inferred as insufficient on the basis of the check.

16. The method as recited in claim 15, wherein, if the fuel quality is found to be insufficient, an error signal is generated.

17. The method as recited in claim 6, wherein, if the error signal is present, a timing of the injections is changed in such a way that disruptions during a combustion brought about as a result of the insufficient fuel quality are compensated for.

18. The method as recited in claim 13, wherein the first and second learning phases are followed by an evaluation phase in which a quotient is formed from the quantity correction learned in the second learning phase and the quantity correction learned in the first learning phase, the quotient being compared with an empirically predefinable value, and the fuel quality is inferred from the result of the comparison of the quotient with the empirically predefinable variable.

19. The method as recited in claim 8, wherein 2 is predefined as the empirical value and the quotient formed is compared with 2.

20. A control unit for controlling injections in an internal combustion engine, comprising:
a coding to carry out method for ascertaining a fuel quality in an internal combustion engine, the method comprising:
carrying out a two-stage zero quantity calibration, wherein:
in a first stage of the calibration, at least one test injection is carried out with a control duration and a first quantity correction is generated,
in a second stage of the calibration, at least two test injections are carried out with the control duration,
a time interval of the control duration is selected in such a way that an influence of a pressure wave that is generated by a first test injection on at least a second test injection is low, and
a second quantity correction is generated on the basis of the at least two test injections;
comparing the first quantity correction and the second quantity correction with one another; and
inferring the fuel quality from a result of the comparing.

21. The method as recited in claim 11, wherein the internal combustion engine is of a motor vehicle.

22. The control unit as recited in claim 20, wherein the internal combustion engine is of a motor vehicle.
